(19) United States
(12) Patent Application Publication
(10) Pub. No.: US 2008/0126177 A1
(43) Pub. Date: May 29, 2008

(54) Stage play advertising and distribution methodology

(76) Inventor: Michael S. Crawford, Houston, TX (US)

Correspondence Address: GORDON G. WAGGETT, P.C., 550 WESTCOTT STREET, SUITE 350, HOUSTON, TX, 77007-5099, US

(21) Appl. No.: 11/811,776

(22) Filed: Jun. 12, 2007

Related U.S. Application Data
(60) Provisional application No. 60/813,066, filed on Jun. 13, 2006.

(51) Int. Cl. G06Q 10/00

(52) U.S. Cl. 705/10; 705/7; 705/14

(57) ABSTRACT

The present invention discloses a new method for modern theatre to find and expand its audience. The result yields an ideal advertisement for future stage productions, as the nature of theatre encourages the reinterpretation of playwrights' works. Presently for a playwright, the process of mailing scripts for consideration for production is arduous and expensive. For a fledgling writer, hundreds of scripts can be mailed before a positive response is received. The present invention allows a playwrights' work to be seen wherever a computer can be taken—the Internet (or other computer network) is limited only by accessibility, and with increasing integration with television, a web browser will soon be a standard part of any media center. In one embodiment, a web-based viewing of a play and script allows a playwrights' work to be viewed in a fully-realized format, from a perspective that recreates the theatrical experience.

### CROSS-REFERENCE TO RELATED APPLICATIONS

This application claims the benefit of the filing date of copending U.S. Provisional Patent Application Ser. No. 60/813,066 fled Jun. 13, 2006, Confirmation No. 1476.

### STATEMENT REGARDING FEDERALLY SPONSORED RESEARCH OR DEVELOPMENT

Not Applicable.

### BACKGROUND OF THE INVENTION

One of the greatest obstacles to a new playwright is finding a venue for production. The less experience and exposure a playwright has yet achieved, the less likely a script is to be closely examined upon submission. Playwrights are left to their own devices as far as publicizing and attempting to encourage interest in a yet-to be-produced work, and are forced to leave their work and its fate in the hands of strangers. This situation led to the recognition of the need for and subsequent development of the present invention, a website referred to herein as “PlaysInPerpetuity.com,” which provides the possibilities for exposure and future production, through a realization of a playwright's ideal vision. A play will merit production by proving it has a potential audience through easily accountable online viewings. Such a monitoring service provides the playwright with marketable data. Audience members can also provide demographic and other information that provides both additional input regarding the play itself as well as detailed demographics regarding the audience. This information can be used by the playwright to enhance the marketability of his or her play.

The present invention is generally directed to a novel methodology towards dramatically widening the scope of a stage play's potential audience. More particularly, the invention allows an ideal presentation of a playwrights' work to serve in and of itself as an ideal advertisement for itself, towards future live productions. The methodology allows works to be viewed at any time, from any place a computer can reach. Further, the potential for furthering the careers of actors involved is extraordinary, due to the breadth of the potential audience and subsequent interest generated thereby. The Internet audience of a unique website is akin to a community unto itself, and the potential for such a community supporting a play and those involved is enormous. Via this methodology, a producer will already be aware of the potential audience of a yet-to-be staged play, or an agent will already be aware of the potential talent of an actor, due to the interest and interactive feedback generated by online viewings of the play.

### BRIEF SUMMARY OF THE INVENTION

In one preferred embodiment of the present invention, there is described a method for a play finding an audience and thereby meriting live onstage production, comprising the following steps: Submission to and acceptance of a script by PlaysInPerpetuity.com; Selection of actors, stage manager and director; Auditions for actors and discussions with possible directors are conducted; Selection of rehearsal space and production space. Production space must be conducive to effective production values, regarding the quality of the end product; Cameraman hiring and scheduling. PlaysinPerpetuity.com has a working relationship established with talented individuals in this field; Pre-publicity of the play on PlaysInPerpetuity.com. Logos, advertising, and synopsis posted; Rehearsal and subsequent decisions regarding nature of and placement of props, and resulting script adjustments, additions and deletions; Filming of play, preferably in digital format; Editing and compression of play for viewing over a computer network; Mounting of the play to a computer/server within the computer network; Providing access to the play to viewers on the network. In another preferred embodiment, a fully filmed play is submitted to PlaysInPerpetuity.com in a format suitable for viewing over a computer network. The play is then mounted to a computer or server within the computer network. The network is ideally the Internet, or other network where viewers having access to the network can view the play.

In a preferred embodiment of the present invention, there is described a method of marketing a stage play, its playwright, actors and others involved in its production comprising the following steps: receiving a script for a play; selecting actors, stage manager and director; selecting rehearsal space and production space; obtaining and scheduling cameramen; providing pre-publicity of the play; conducting rehearsals and making subsequent decisions regarding nature of and placement of props, and resulting script adjustments, additions and deletions; filming of the play as presented on a stage; editing and compression of the play for viewing over a computer network; mounting of the edited and compressed filmed version of the play to a computer/server within the computer network; and providing access to the play to viewers on the network. In a preferred embodiment, the computer network is the Internet, and access to the play is provided to viewers via an interactive website. Data on the number of times the play has been viewed from the website can be compiled. Feedback from the viewers of the play can be obtained. The data and feedback can be shared with others. In one preferred embodiment, the filming of the play utilizes a single camera maintaining a fixed viewpoint relative to the stage throughout the entirety of the play. The filmed play can be edited so that the play can be viewed in its entirety, per act or per scene.

In yet another preferred embodiment of the present invention, there is disclosed a method of marketing a stage play comprising the following steps: receiving a stage play that has been audio and visually recorded onto a media; mounting the media to a computer/server within an Internet-based computer network; and providing access to the play to viewers on the network. In this embodiment, the play can likewise be provided to viewers via an interactive website.

In one preferred embodiment, the plays are provided for viewing over the network at no charge to the viewers. Additionally, a copy of the script can be provided for viewing.

Advertising content can be provided on the website, and if desired, a copy of the recorded play or its script can be made available for purchase through the website. Additionally, theatre memorabilia, or other merchandise can be offered relating to theatre in general and/or to one or more of the specific plays.

Preferably, the computer network is the Internet and the play is mounted on a website. Also, in one preferred embodiment, the play is mounted to the server in a format that protects against unauthorized copying or duplication. One preferred method of protecting the content of the stored play on the server is by storing the play on the server as Flash Viewer content so that viewers may only view, but not copy or store the content. In another preferred embodiment, the plays may be viewed by viewers at no charge.

### BRIEF DESCRIPTION OF THE SEVERAL VIEWS OF THE DRAWINGS

FIG. 1 shows a schematic diagram of a computer network, such as the Internet, utilizing the present invention according to a preferred embodiment of the present invention.

FIG. 2 shows a schematic diagram of a computer network, such as the Internet, utilizing the present invention according to a preferred embodiment of the present invention.

### DETAILED DESCRIPTION OF THE INVENTION

The PlaysinPerpetuity.com methodology and program of the present invention is a novel approach to greatly increasing the possibilities of a stage play script finding a producer. The invention allows a play to serve as its own advertisement, as an ideal version is distributed to whomever wishes to view it, at any time and any place a computer can reach. The play itself is offered for viewing over a computer network, such as the Internet. All involved in any way receive exposure.

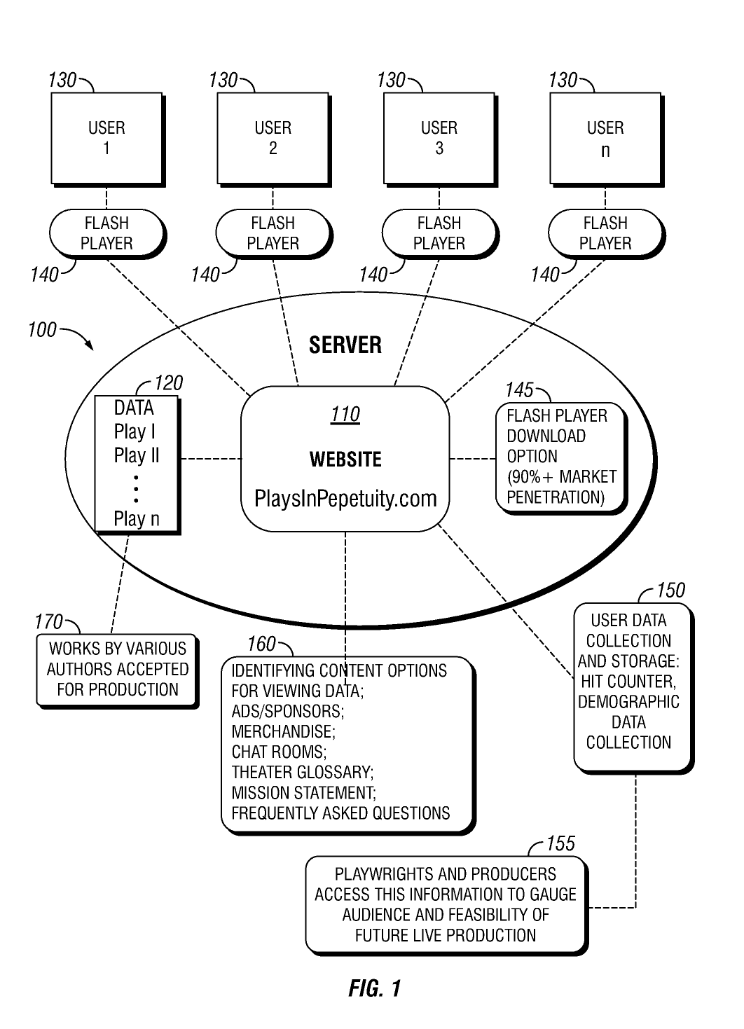

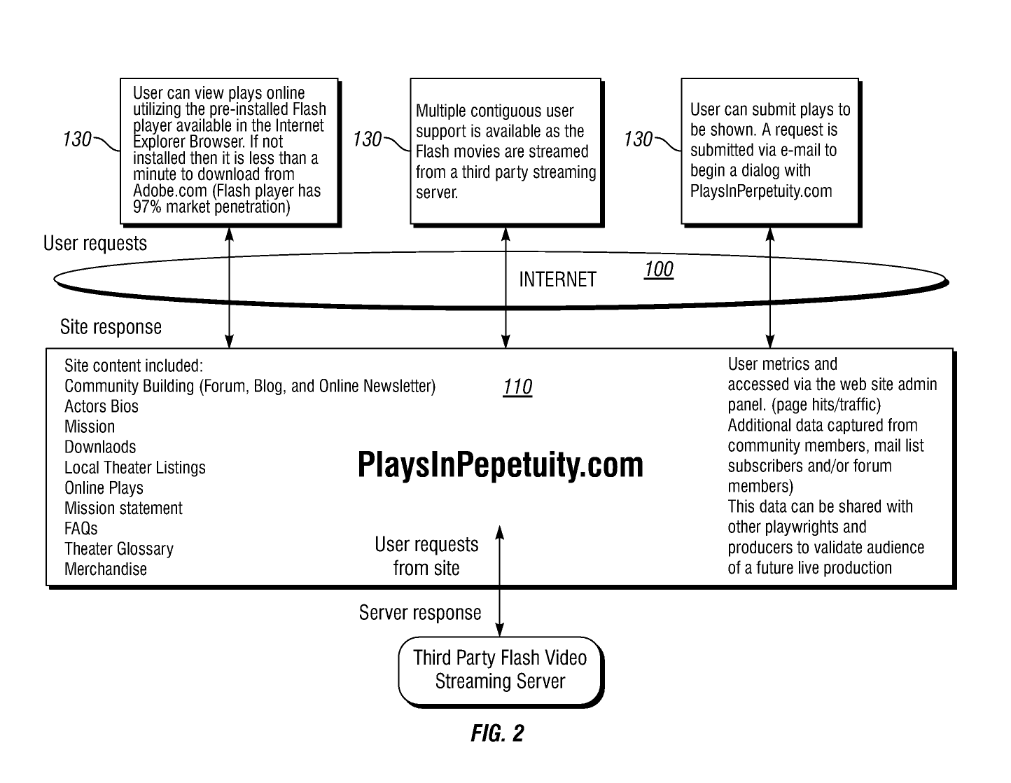

Referring now to FIG. 1 and FIG. 2 there are generally depicted schematic diagrams of a computer network 100, such as the Internet, utilizing the present invention according to preferred embodiments of the present invention. As will be readily appreciated, many different configurations, well known in the art, can be used to achieve the benefits of the present invention. For example, in a preferred embodiment, a website 110, such as PlaysInPerpetuity.com offers one or more plays (data; Play I-Play n) 120 online, as well as how to reach the writer, director, actors and all who offer any input in the plays' creation and posting upon PlaysInPerpetuity.com. As generally depicted in FIG. 1, a computer network 100 is provided to allow multiple users 130 (User 1, User 2, . . . . User n) to gain access to recorded versions of any number of plays (Play I, Play II, . . . . Play n) 120. The Users 130 could be anyone interested in viewing one of the plays: for example, members of the professional theatre community, producers, talent agencies, university and school theatre departments, and the general population. Preferably the plays are filmed in digital format, but any format can be used so long as the format can be viewed over the computer network. In a preferred embodiment, the digital content (e.g., Play I, . . . . Play n) 120 is stored as Flash Player format to prevent unauthorized copying and distribution—in other words, the users of the network can view the plays over the network, but cannot copy them. For many users, a Flash Player 140 will be provided with their computer software, but for those needing a Flash Player, said player can be downloaded from the Internet directly from the source, or via a link 145 provided on the PlaysInPerpetuity.com website 110.

The actual content of the plays, as filmed, may take a number of forms. For example, as described further herein, the play can be filmed from a single camera viewpoint (such as would be the viewpoint of someone sitting in a theatre seat viewing the play). In a preferred embodiment, the camera viewpoint remains fixed, i.e., there is no panning or zooming of the camera. Using a single, fixed camera viewpoint provides a simple, cost effective means for filming a play for use with the present invention. In this embodiment, in every possible sense, the essence of live theatre is preserved.

However, multiple camera viewpoints (such as would be the viewpoints of persons sitting in different theatre seats viewing the play, e.g., stage right, stage left, center, etc.) could also be employed. In another preferred embodiment, the camera (or cameras) pans and zooms to provide, e.g., close-up views of the actors or sets (much like that capable with a set of theatre binoculars). Although an object of the present invention is to provide a simple means for having a playwright's play reviewed, an elaborate digitally filmed version of the play could be produced for viewing in accordance with the present invention.

In a preferred embodiment, the website 110 contains standard identifying content for the host and site itself, but also contains features useful for furthering the objectives of the present invention. For example, the website 110 can identify its mission regarding the promotion of theatre, and provide a section on frequently asked questions. The Flash Player could provide the ability for the user/viewer to zoom in (enlarge) the view (preferably without loss of picture quality), to pause, rewind, etc. the play as may be desired. Preferably, the Flash Player skin will be unique to the host website 110 (e.g., PlaysInPerpetuity.com). Also, if multiple camera angles are employed, the website could either offer these for separate viewing, or provide the viewer with the option to view the play on a number of different screens. Additionally, the play 120 could be made available for viewing in its entirety, by acts, and/or by scenes. When viewed in its entirety, in a preferred embodiment, the Flash Player content will be provided in a seamless manner so that there are no interruptions in the viewing of the play.

Also, much like is possible with current website behind-the-scenes monitoring, the website 110 could monitor the number of “hits” (views or “Flash” downloads) of the play (or acts or scenes from the play). This indirect user input 150 will be valuable data for the playwright (or producers) to judge the interest level of his or her play 155. Direct user input could also be solicited to provide feedback on any number of topics relating to the play, including the user's critical review and commentary, comments about the actors and set, etc. The host website could also provide interactive content 160, such as by hosting Chat Rooms for users/viewers to exchange commentaries about the plays they viewed via the website. The website could also provide other useful information, such as in the form of a digital program providing a synopsis of the play, biographies/photos of the playwright, actors and other crew used, much like as is used in a theatre showing a live play. The website could also include other information that might be of interest to the users/viewers, such as a glossary of theatre.

Prior to the present invention, a completed stage play script by a new playwright was subject to a highly impersonal system where hundreds of scripts are mailed, with no real knowledge on the part of the playwright of who will be making choices that effect his or her future. The PlaysinPerpetuity.com model circumvents this process by staging a play online, where it can find its own audience and stand or fall based upon its own merits. Submissions from any playwright can be accepted 170, via email or other mechanisms, thus widening the possibilities for modern theatre to reach a new and relatively limitless audience. Where before perhaps 250-1000 eyes might have viewed a new work, there exists exponential potential regarding exposure, and subsequent interest in live production of the new work.

A preferred objective of the present invention for plays viewed via a computer network, such as the website PlaysinPerpetuity.com, is to garner sufficient interest to warrant production of the play in a true theatrical environment before a live audience.

Theatre is unique in that, unlike a movie, every performance is different, in some form or fashion. PlaysinPerpetuity.com allows a play to reach an audience who is not seeing it in its ideal environment: live, onstage. With sufficient interest, easily gauged through audience tracking software, chat room and other audience feedback/surveys, an argument can easily be mounted to a producer that a show is a viable investment. And, producers may seek out the playwright after viewing the play on PlaysinPerpetuity.com, and find them easily accessible through the website. Likewise, the actors and others associated with the online production garner marketing exposure that can lead a furtherance of their respective careers. As such, PlaysinPerpetuity.com can serve as an organized, centralized hub for advertising stage plays—a virtual, web-based clearinghouse for modern theatre. It can also serve as a brokerage or agency for further distribution and use of the copyrighted content or talents contained in the play. The data collected and stored about the play can be used in many different ways, such as, for example and without limitation, an actor in the play might use the data to interest a talent agent to further the actor's career; a playwright can use the data to interest the professional theatrical community in the play; PlaysInPerpetuity.com can serve as a talent broker using such data, etc.

PlaysInPerpetuity.com will provide as perfect an example of the playwright's truest intentions as can be created, and allow producers and directors (and others) to view the work, recognize a potential audience and have an unprecedented opportunity to experience precisely what a playwright wishes to impart.

The PlaysinPerpetuity.com website 110 preferably contains a number of different, theatrically-themed subject areas. A Theatre Glossary, a Frequently Asked Questions section, a Mission Statement, author blog and other pages combine to create an absorbing and interesting surrounding environment, of which the filmed plays serve as a centerpiece. Interactive areas 160 (chat rooms, on-line discussions with actors and playwrights, etc.), allow the audience 130 to feel and be part of the website's community. The audience will also have the opportunity to provide demographic data 150 significant to future marketing of a play (and/or of the talents used in the play).

In a preferred embodiment, PlaysinPerpetuity.com films plays, but does not make its plays into films. In this embodiment, a true theatrical experience is maintained by utilizing one camera, with a fixed point of view and perspective. The filming process is simple, and mirrors the experience of an audience member at a live stage play. The camera's lens encompasses the entire stage, but provides clarity—the camera utilized provides a view comparable, in terms of detail and crispness, to that of a preferable seat in a theater. Perspective and location are fixed, as an audience member is entitled to only one seat, and one point of viewing. This seeming limitation is an important part of theatre, as a playwright's and director's job is to work around the audience's limited (relative to movies or television utilizing camera angles) view, and turn disadvantage to advantage. A close-up of a tear, for example, is not an option in theatre, nor is it in this preferred embodiment. The actor involved must instead evoke that feeling or realization in the audience by other means, and in this embodiment, PlaysInPerpetuity.com presents the play with respect for the rules and seeming limitations of theatre. In every way possible, in this embodiment, the impression of sitting in a theater seat, just after the lights go down, will be encouraged. In this embodiment, PlaysInPerpetuity.com allows playwrights' work to be viewed in a fully-realized format, from a perspective that recreates the theatrical experience.

Additionally, in a preferred embodiment, the PlayInPerpetuity.com website 110 is designed to contain space 160 for advertising, in a manner not unlike a real theater. Audience interest and website hits can be used in determining the nature and amount of advertising. Additionally, the website can contain an electronic “program” formatted to resemble those typically handed to audience members as they enter the theatre. For example, the program can contain information about the play, the playwright, actors, production crew, etc., as well as advertisements or other acknowledgements.

PlaysInPerpetuity.com will allow playwrights' work to be seen wherever a computer can be taken—the Internet is limited only by accessibility, and with increasing integration with television, a web browser will soon be a standard part of any media center.

The information compiled can serve as an unprecedented calling card for use by the playwright/actor, etc. in obtaining the interest of an agent and/or a producer 155. In one embodiment, the audience (users/viewers) 130 or others can set up an account with the web host to interactively gain access 155 to such complied information.

Although in a preferred embodiment of the present invention the computer network is Internet-based, other computer networks could employ the invention, such as an intranet audience of a computer network community found within in a university, an actors' organization, or professional theatrical community, to name but a few examples.

While the present invention has been described in terms of preferred embodiments, it will be apparent to those of skill in the art that variations may be applied to the process and system described herein without departing from the concept and scope of the invention. All such similar substitutes and modifications apparent to those skilled in the art are deemed to be within the scope and concept of the invention. Those skilled in the art will recognize that the methodologies of the present invention have many applications, and that the present invention is not limited to the representative examples disclosed herein. Moreover, the scope of the present invention covers conventionally known variations and modifications to the system components described herein, as would be known by those skilled in the art. All such similar substitutes and modifications apparent to those skilled in the art are deemed to be within the scope and concept of the invention as it is set out in the following claims.

I claim:

1. A method of marketing a stage play, its playwright, actors and others involved in its production, comprising the following steps:
a. receiving a script for a play;
b. selecting actors, stage manager and director;
c. selecting rehearsal space and production space;
d. obtaining and scheduling cameramen;
e. providing pre-publicity of the play;
f. conducting rehearsals and making subsequent decisions regarding nature of and placement of props, and resulting script adjustments, additions and deletions;
g. filming of the play as presented on a stage;
h. editing and compression of the play for viewing over a computer network;
i. mounting of the edited and compressed filmed version of the play to a computer/server within the computer network; and
j. providing access to the play to viewers on the network.

2. The method of claim 1 wherein the computer network is the internet.

3. The method of claim 2 wherein access to the play is provided to viewers via an interactive website.

4. The method of claim 3 comprising the additional step of compiling data on the number of times the play has been viewed from the website.

5. The method of claim 3 comprising the additional step of obtaining feedback from the viewers of the play.

6. The method of claim 4 comprising the additional step of sharing the compiled data with another person.

7. The method of claim 5 comprising the additional step of sharing the obtained feedback with another person.

8. The method of claim 1 wherein the filming of the play utilizes a single camera maintaining a fixed viewpoint relative to the stage throughout the entirety of the play.

9. The method of claim 1 wherein the editing step includes formatting the filmed play so that the play can be viewed in its entirety, per act or per scene.

10. The method of claim 3 wherein the script is also available for viewing via the website.

11. A method of marketing a stage play comprising the following steps:
a. receiving a stage play that has been audio and visually recorded onto a media;
b. mounting the media to a computer/server within an internet-based computer network; and
c. providing access to the play to viewers on the network.

12. The method of claim 10 wherein access to the play is provided to viewers via an interactive website.

13. The method of claim 11 comprising the additional step of compiling data on the number of times the play has been viewed from the website.

14. The method of claim 11 comprising the additional step of obtaining feedback from the viewers of the play.

15. The method of claim 12 comprising the additional step of sharing the compiled data with another person.

16. The method of claim 13 comprising the additional step of sharing the obtained feedback with another person.

17. The method of claim 11 comprising the additional step of providing advertising content on the website.

18. The method of claim 11 comprising the additional step of providing a copy of the recorded play for purchase through the website.

19. The method of claim 11 comprising the additional step of providing theater memorabilia, or other merchandise relating to the theater in general and/or to one or more of the specific plays.
